(19) United States
(12) Patent Application Publication
(10) Pub. No.: US 2017/0158134 A1
(43) Pub. Date: Jun. 8, 2017

(54) IMAGE DISPLAY DEVICE AND IMAGE DISPLAY METHOD

(71) Applicant: DENSO CORPORATION, Kariya-city, Aichi-pref. (JP)

(72) Inventor: Shusaku Shigemura, Kariya-city, Aichi-pref. (JP)

(73) Assignee: DENSO CORPORATION, Kariya-city, Aichi-pref (JP)

(21) Appl. No.: 15/320,498

(22) PCT Filed: Jun. 23, 2015
(86) PCT No.: PCT/JP2015/003132

§ 371 Date: Dec. 20, 2016

(30) Foreign Application Priority Data
Jul. 3, 2014 (JP) 2014-137561

(51) Int. Cl. B60R 1/00; G06K 9/78; H04N 5/445; G06K 9/00; H04N 5/232; H04N 7/18

(52) U.S. Cl. CPC B60R 1/002; H04N 5/23238; H04N 5/23293; H04N 7/181; H04N 5/44504; G06K 9/00805; G06K 9/78; B60R 2300/105; B60R 2300/607; B60R 2300/70; B60R 2300/8033; B60R 2300/8066; B60R 2300/8093

(57) ABSTRACT

An image display device for displaying an image showing surrounding of a vehicle in a bird's eye view style is provided. The image display device includes a bird's eye view image generation section that generates, based on an image captured by an on-vehicle camera, a bird's eye view image showing the surrounding of the vehicle in the bird's eye view style, a vehicle image combination section that combines a vehicle image showing the vehicle with the bird's eye view image by placing the vehicle image at a position of the vehicle in the bird's eye view image, and an image output section that, from the bird's eye view image with which the vehicle image is combined, cuts out a predetermined scope in accordance with the shift position of the vehicle, and outputs the cut-out image to the display screen.

### CROSS-REFERENCE TO RELATED APPLICATION

This application is based on Japanese Patent Application No. 2014-137561, filed on Jul. 3, 2014, the disclosure of which is incorporated herein by reference.

### TECHNICAL FIELD

The present disclosure relates to a technology for displaying an overhead image on a display screen in such a manner as to present an overhead view of the surroundings of a vehicle.

### BACKGROUND ART

There is a well-known technology for enabling a driver of a vehicle to confirm the surroundings of the vehicle by capturing an image of the surroundings of the vehicle by using on-vehicle cameras mounted on the front and rear (and the left and right) of the vehicle and displaying the captured image on a display screen disposed in a vehicle compartment.

Further, there is also a developed technology (Patent Literature 1) that converts images captured by on-vehicle cameras to an overhead image of a vehicle and displays the obtained overhead image on a display screen. Consequently, the overhead image is displayed in such a manner that it is obtained when viewed from above the vehicle (in a bird's eye view). It has been believed that the distance, for example, to obstacles existing around the vehicle and their positional relationship to the vehicle can easily be grasped when images captured by on-vehicle cameras are displayed in an overhead bird's eye view instead of being displayed in a simple manner.

### PRIOR ART LITERATURE

### Patent Literature

Patent Literature 1: JP2012-066724A

### SUMMARY OF INVENTION

However, studies conducted by the inventor of the present application imply that it is not always easy for a driver of a vehicle to properly grasp the surroundings of the vehicle when images captured by on-vehicle cameras are simply displayed in a bird's eye view.

The reason is that a display screen mountable in a vehicle compartment is small in size. When, for instance, an obstacle is displayed in a size easily recognizable by the driver, only an area close to the vehicle can be displayed. Thus, the display screen does not adequately enable the driver to grasp the surroundings of the vehicle. Meanwhile, if an attempt is made to display an area far from the vehicle, an object such as an obstacle is displayed in a small size. Therefore, even when the driver looks at the display screen, the driver does not easily recognize the existence of an object such as an obstacle.

In view of the above circumstances, an object of the present disclosure is to provide a technology that enables a driver of a vehicle to easily grasp the surroundings of the vehicle by displaying an overhead bird's eye view image of the vehicle.

An example in the present disclosure provides an image display device that is applied to a vehicle equipped with an on-vehicle camera and a display screen for displaying an image captured by the on-vehicle camera, and that displays on the display screen an image showing the surrounding of the vehicle in a bird's eye view style for showing an overhead view of the vehicle. The image display device comprises: a captured image acquisition section that acquires the captured image from the on-vehicle camera; a bird's eye view image generation section that generates, based on the captured image, a bird's eye view image showing the surrounding of the vehicle in the bird's eye view style; a vehicle image combination section that combines a vehicle image showing the vehicle with the bird's eye view image by placing the vehicle image at a position of the vehicle in the bird's eye view image; a shift position detection section that detects a shift position of the vehicle; and an image output section that cuts out a predetermined scope corresponding to the shift position of the vehicle from the bird's eye view image with which the vehicle image is combined and outputs the cut-out image to the display screen. Another example in the present disclosure provides an image display method that is applied to a vehicle having an on-vehicle camera and a display screen for displaying an image captured by the on-vehicle cameras, and that displays on the display screen an image showing the surrounding of the vehicle in a bird's eye view style for showing an overhead view of the vehicle. The image display method comprise: a step of acquiring the captured image from the on-vehicle camera; a step of generating a bird's eye view image based on the captured image, the bird's eye view image being adapted to show the surrounding of the vehicle in the bird's eye view style; a step of combining a vehicle image showing the vehicle with the bird's eye view image by placing the vehicle image at the position of the vehicle in the bird's eye view image; a step of detecting a shift position of the vehicle; and a step of cutting out a predetermined scope corresponding to the shift position of the vehicle from the bird's eye view image with which the vehicle image is combined, and outputting the cut-out image to the display screen.

The scope of the surroundings of the vehicle that the driver wants to grasp varies with a shift position. Therefore, when the image showing the predetermined scope is cut out from the bird's eye view image in accordance with the shift position, the driver can easily grasp the surroundings of the vehicle even if the display screen is small.

### BRIEF DESCRIPTION OF DRAWINGS

The above and other objects, features, and advantages of the present disclosure will become more apparent from the following detailed description made with reference to the accompanying drawings. In the drawings:

FIG. 1 is a diagram illustrating a vehicle in which an image display device according to an embodiment of the present disclosure is mounted;

FIG. 2 is a schematic diagram illustrating an internal configuration of the image display device;

FIG. 3 is a flowchart illustrating a bird's eye view image display process performed by the image display device according to the embodiment;

FIG. 4 is a diagram illustrating images captured by a plurality of on-vehicle cameras;

FIG. 5 is a flowchart illustrating a target object detection process;

FIG. 6 is a diagram illustrating corrected images obtained by correcting aberrations in captured images;

FIG. 7 is a diagram illustrating how the target object detection process stores coordinate values of white lines;

FIG. 8A is a diagram illustrating how the target object detection process stores coordinate values of a pedestrian;

FIG. 8B is a diagram illustrating how the target object detection process stores coordinate values of a pedestrian;

FIG. 9 is a diagram illustrating how the target object detection process stores coordinate values of an obstacle;

FIG. 10 is a diagram illustrating a method of converting coordinate values in a corrected image to coordinate values in a coordinate system whose origin is the vehicle; h

FIG. 11 is a diagram illustrating a bird's eye view image generated by a bird's eye view image display process according to the embodiment;

FIG. 12 is a diagram illustrating pedestrians and an obstacle that are significantly distorted in a bird's eye view image generated by subjecting captured images to viewpoint conversion;

FIG. 13 is a diagram illustrating how a predetermined scope is cut out from a bird's eye view image in accordance with a shift position;

FIG. 14 is a diagram illustrating how the scope of a bird's eye view image displayed on a display screen changes when the shift position is changed from N (Neutral) to R (Reverse); and

FIG. 15 is a diagram illustrating how the scope of the bird's eye view image displayed on the display screen changes when the shift position is changed from N (Neutral) to D (Drive).

### DESCRIPTION OF EMBODIMENTS

An embodiment of the present disclosure will now be described.

A. Device Configuration

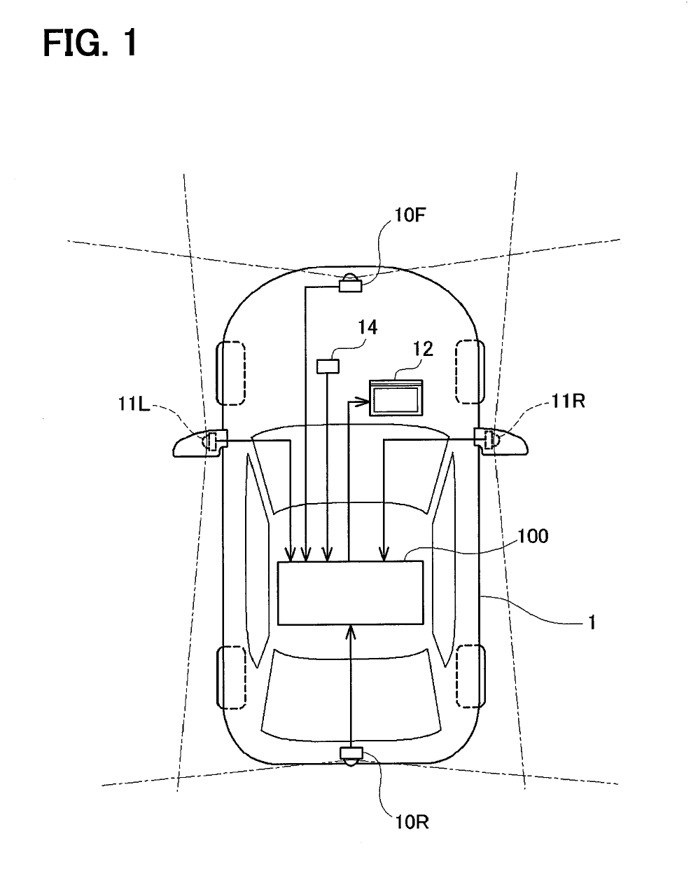

FIG. 1 illustrates a vehicle 1 in which an image display device 100 is mounted. As illustrated, the vehicle 1 includes an on-vehicle camera 10F, an on-vehicle camera 10R, an on-vehicle camera 11L, and an on-vehicle camera 11R. The on-vehicle camera 10F is mounted on the front of the vehicle 1 to capture an image showing a forward view from the vehicle 1. The on-vehicle camera 10R is mounted on the rear of the vehicle 1 to capture an image showing a rearward view from the vehicle 1. The on-vehicle camera 11L is mounted on the left side of the vehicle 1 to capture an image showing a leftward view from the vehicle 1. The on-vehicle camera 11R is mounted on the right side of the vehicle 1 to capture an image showing a rightward view from the vehicle 1. Image data on the images captured by the on-vehicle cameras 10F, 10R, 11L, 11R are inputted to the image display device 100 and then subjected to a later-described predetermined process. As a result, an image appears on a display screen 12. In the present embodiment, the image display device 100 is formed of a so-called microcomputer that is configured by connecting, for example, a CPU, a ROM, and a RAM through a bus in such a manner as to permit data exchange.

The vehicle 1 also includes a shift position sensor 14 that detects the shift position of a transmission (not shown). The shift position sensor 14 is connected to the image display device 100. Therefore, based on an output from the shift position sensor 14, the image display device 100 is able to detect the shift position (Drive, Neutral, Reverse, or Park) of the transmission.

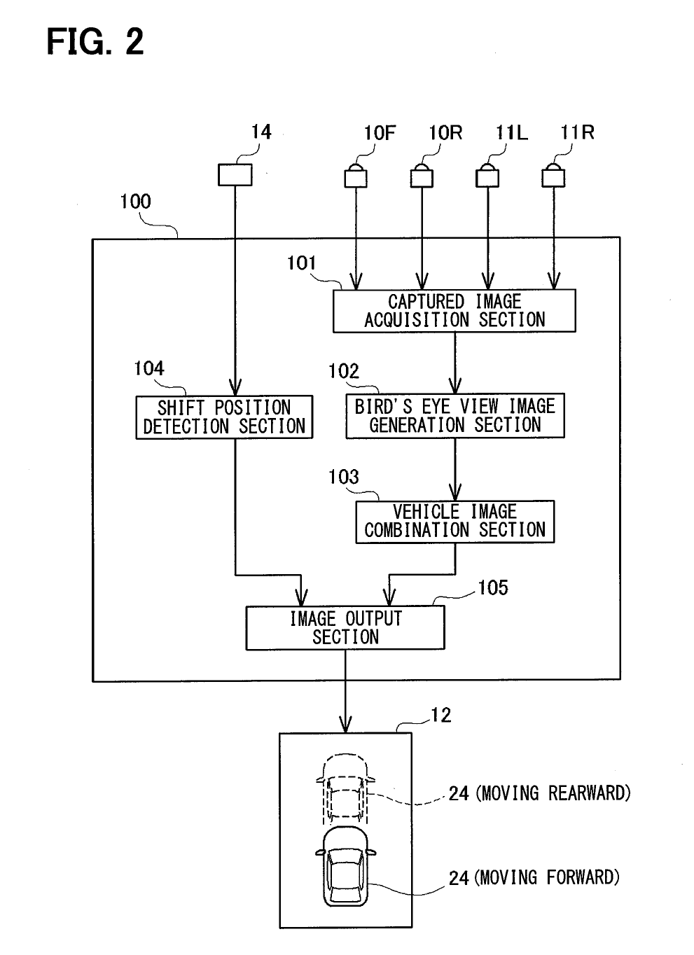

FIG. 2 schematically illustrates an internal configuration of the image display device 100 according to the present embodiment. As illustrated, the image display device 100 according to the present embodiment includes a captured image acquisition section 101, a bird's eye view image generation section 102, a vehicle image combination section 103, a shift position detection section 104, and an image output section 105.

The above-mentioned five “sections” are abstractions into which the interior of the image display device 100 is classified in consideration of functions of the image display device 100 that displays an image of the surroundings of the vehicle 1 on the display screen 12. The five “sections” do not indicate that the image display device 100 is physically divided into five sections. Thus, these “sections” can be implemented as computer programs executable by a CPU, as electronic circuits including an LSI or a memory, or by combining the computer programs and the electronic circuits.

The captured image acquisition section 101 is connected to the on-vehicle cameras 10F, 10R, 11L, 11R in order to acquire, at predetermined intervals (at intervals of approximately 30 Hz), images of the surroundings of the vehicle 1, which are captured by the on-vehicle cameras 10F, 10R, 11L, 11R. The captured image acquisition section 101 outputs the acquired captured images to the bird's eye view image generation section 102.

The bird's eye view image generation section 102 receives the captured images from the captured image acquisition section 101, and based on the received captured images, generates a bird's eye view image that shows the surroundings of the vehicle 1 in an overhead view style (in a bird's eye view style). A method of generating the bird's eye view image from the captured images will be described in detail later. When the bird's eye view image is to be generated, processing is performed to extract target objects shown in the captured images, such as pedestrians and obstacles, and detect the positions of detected target objects relative to the vehicle 1. In the present embodiment, therefore, the bird's eye view image generation section 102 corresponds to a “target object extraction section” and to a “relative position detection section” in claims.

The vehicle image combination section 103 combines a vehicle image 24, which shows the vehicle 1, with the bird's eye view image by overwriting the bird's eye view image, which is generated by the bird's eye view image generation section 102, with the vehicle image 24. This overwrite is performed by placing the vehicle image 24 at a position where the vehicle 1 exists within the bird's eye view image. Various images may be used as the vehicle image 24. For example, a captured image showing an overhead view of the vehicle 1, an animation image showing an overhead view of the vehicle 1, or a symbolic image representing an overhead view of the vehicle 1 may be used as the vehicle image 24. The vehicle image 24 is stored in a memory (not shown) of the image display device 100.

The bird's eye view image obtained in the above manner is too large in area to be directly displayed on the display screen 12. However, if the bird's eye view image is reduced in size until it fits the display screen 12, the displayed image is too small.

Consequently, based on a signal from the shift position sensor 14, the shift position detection section 104 detects the shift position (Drive, Reverse, Neutral, or Park) of the transmission and outputs the result of detection to the image output section 105.

The image output section 105 then cuts out a predetermined scope from the bird's eye view image with which the vehicle image is combined by the vehicle image combination section 103. The scope to be cut out is predetermined based on the shift position. The image output section 105 eventually outputs the cut-out image to the display screen 12.

Upon receipt of the cut-out image, the display screen 12 is able to display a sufficiently large bird's eye view image. This makes it easy for a driver of the vehicle 1 to recognize the presence, for example, of an obstacle, a pedestrian, or other object around the vehicle 1.

B. Bird's Eye View Image Display Process

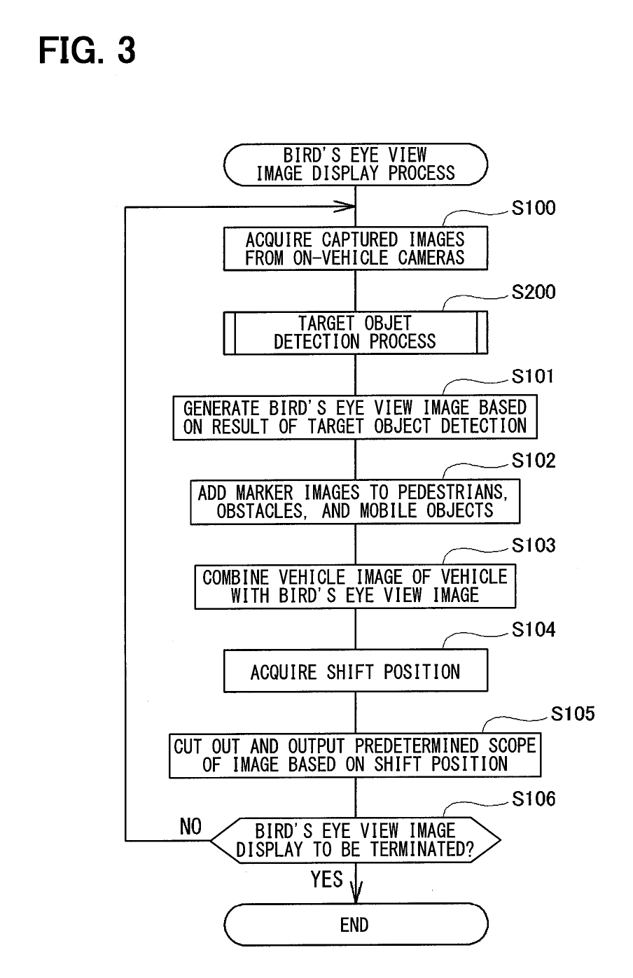

FIG. 3 is a flowchart illustrating a bird's eye view image display process performed by the above-described image display device 100.

The bird's eye view image display process is started by acquiring captured images from the on-vehicle cameras 10F, 10R, 11L, 11R (S100). More specifically, a captured image showing a forward view from the vehicle 1 (forward image 20) is acquired from the on-vehicle camera 10F, which is mounted on the front of the vehicle 1, and a captured image showing a rearward view from the vehicle 1 (a rearward image 23) is acquired from the on-vehicle camera 10R, which is mounted on the rear of the vehicle 1. Similarly, a captured image showing a leftward view from the vehicle 1 (leftward image 21) is acquired from the on-vehicle camera 11L, which is mounted on the left side of the vehicle 1, and a captured image showing a rightward view from the vehicle 1 (a rightward image 22) is acquired from the on-vehicle camera 11R, which is mounted on the right side of the vehicle 1.

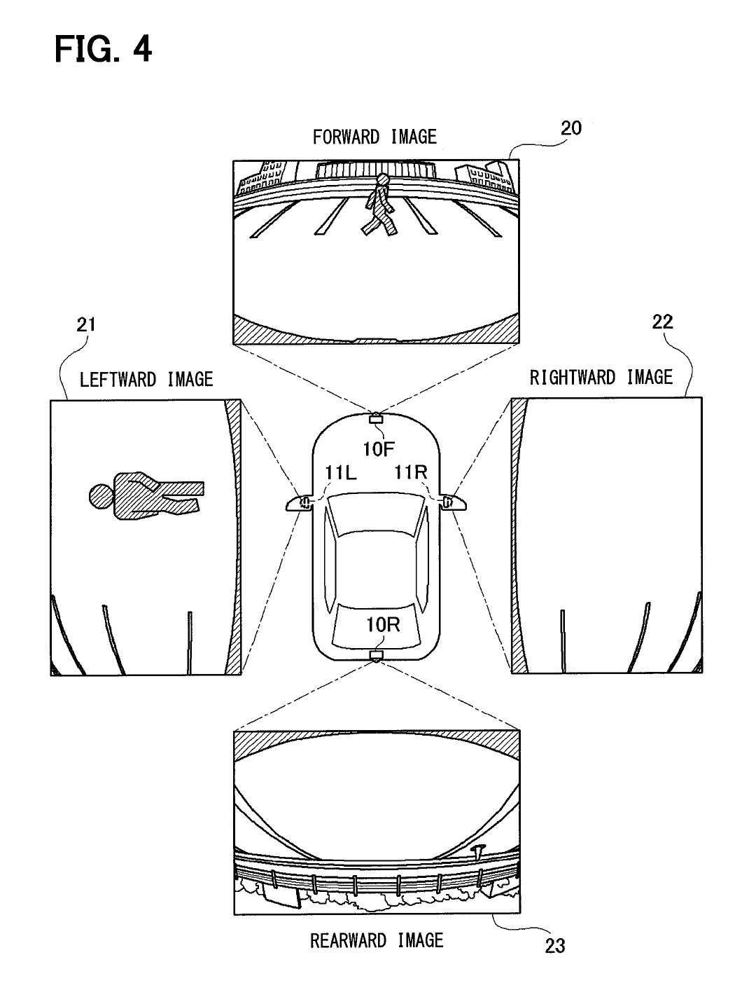

FIG. 4 illustrates how the forward image 20, the leftward image 21, the rightward image 22, and the rearward image 23 are acquired from the four on-vehicle cameras 10F, 10R, 11L, 11R.

Subsequently, a process of detecting target objects existing around the vehicle 1 (target object detection process) starts based on the above-mentioned captured images (S200). The target objects are predefined targets to be detected, such as pedestrians, automobiles, two-wheeled vehicles, and other mobile objects, and power poles and other obstacles to the running of the vehicle 1.

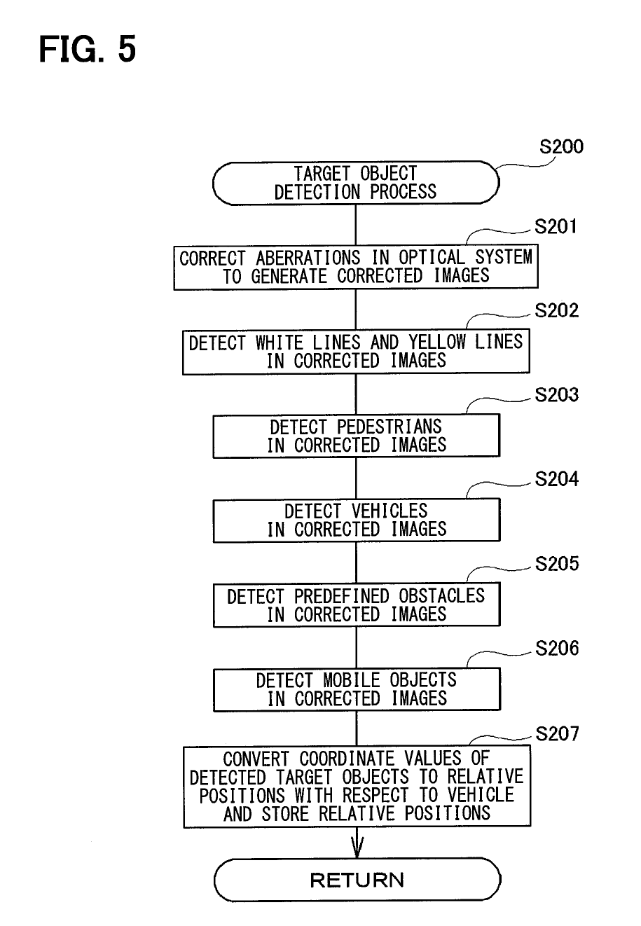

FIG. 5 is a flowchart illustrating the target object detection process. As illustrated, when the target object detection process starts, corrected images are first generated by correcting optical aberrations in the images acquired from the on-vehicle cameras 10F, 10R, 11L, 11R (S201). The optical aberrations can be predetermined for each on-vehicle camera 10F, 10R, 11L, 11R by calculations or by an experimental method. Data on the aberrations of each on-vehicle camera 10F, 10R, 11L, 11R is stored beforehand in the memory (not shown) of the image display device 100. Corrected images without aberrations can be obtained by correcting the captured images in accordance with the data on the aberrations.

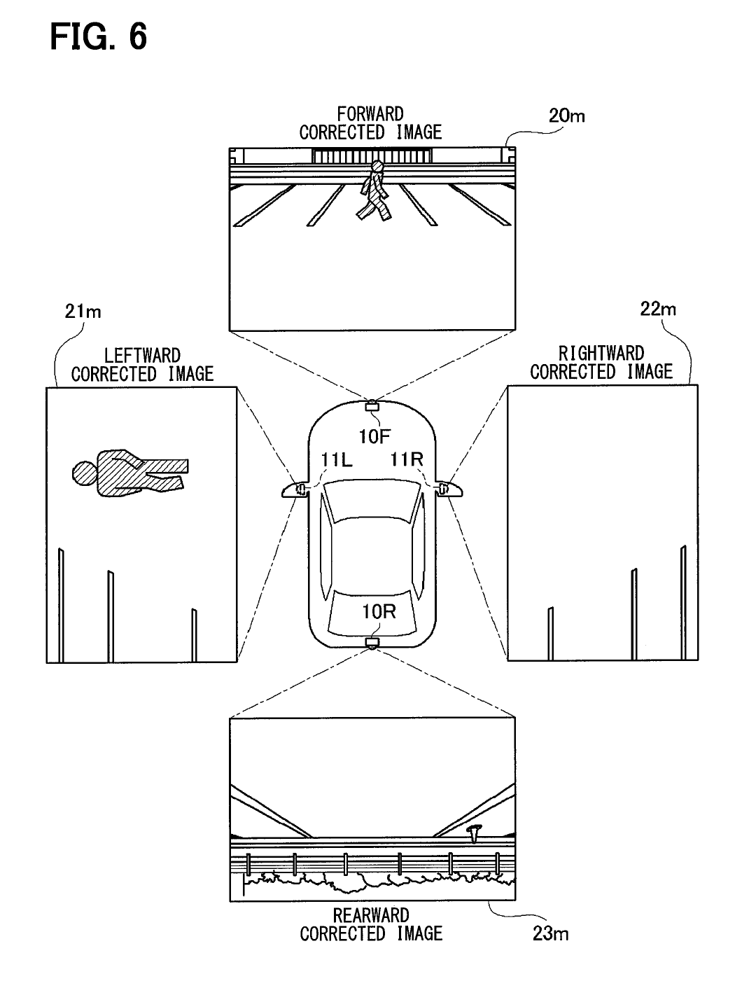

FIG. 6 illustrates obtained corrected images without aberrations, namely, a forward corrected image 20m, a leftward corrected image 21m, a rightward corrected image 22m, and a rearward corrected image 23m.

When the corrected images are obtained as described above, white lines and yellow lines are detected from each of the corrected images (S202). The white or yellow lines can be detected by locating a portion of an image that abruptly changes in brightness (a so-called edge) and extracting a white or yellow part from a region enclosed by the edge.

When a white or yellow line is detected, a check is performed to determine whether the line is detected from the forward corrected image 20m, the leftward corrected image 21m, the rightward corrected image 22m, or the rearward corrected image 23m. Further, the coordinate values of the line in the corrected image are determined. These results of determination are then stored in the memory of the image display device 100.

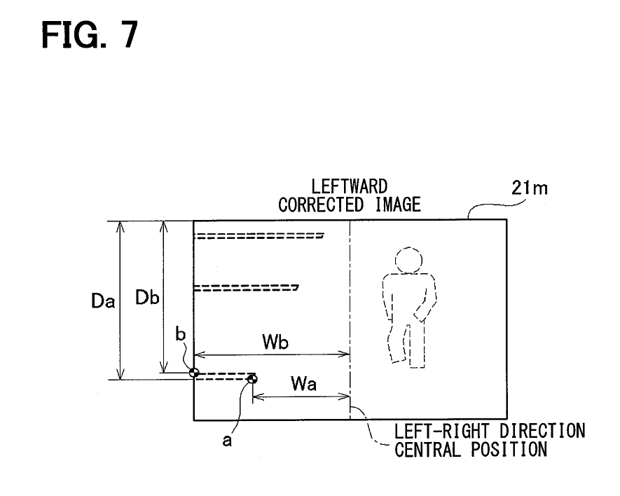

FIG. 7 illustrates how the coordinate values of detected white lines are stored. In the example of FIG. 7, the contour of each white line is divided into straight lines, and then the coordinate values of intersections of the straight lines are stored. As regards, for example, the foremost white line, four straight lines are detected. Thus, the coordinate values of four intersections of the straight lines are stored. In order to avoid complicatedness, FIG. 7 depicts only two out of four intersections, namely, intersections a and b. For example, coordinate values (Wa, Da) are stored for intersection a, and coordinate values (Wb, Db) are stored for intersection b. In the example of FIG. 7, a left-right direction coordinate value is defined with respect to the central position of an image, which serves as the origin, in such a manner that a negative value increases in the leftward direction and that a positive value increases in the rightward direction. Further, an up-down direction coordinate value is defined with respect to the upper side of the image, which serves as the origin, in such a manner that a positive value increases in the downward direction.

Subsequently, a pedestrian in each corrected image is detected (S203). Pedestrians in each corrected image are detected by searching for pedestrians by using a template that describes features of an image showing a pedestrian. When a portion of a corrected image that matches the template is found, it is determined that the portion shows a pedestrian. Images of pedestrians may be captured in various sizes. Therefore, when appropriate templates of various sizes are stored and used for an image search, pedestrians of various sizes can be detected. Additionally, the template used in the detection can provide information about the size of the pedestrian in the captured image.

Further, when a pedestrian is detected, the memory of the image display device 100 stores information indicating whether the pedestrian is detected from the forward corrected image 20m, the leftward corrected image 21m, the rightward corrected image 22m, or the rearward corrected image 23m, and stores the relevant coordinate values in the corrected image, and the size of the pedestrian.

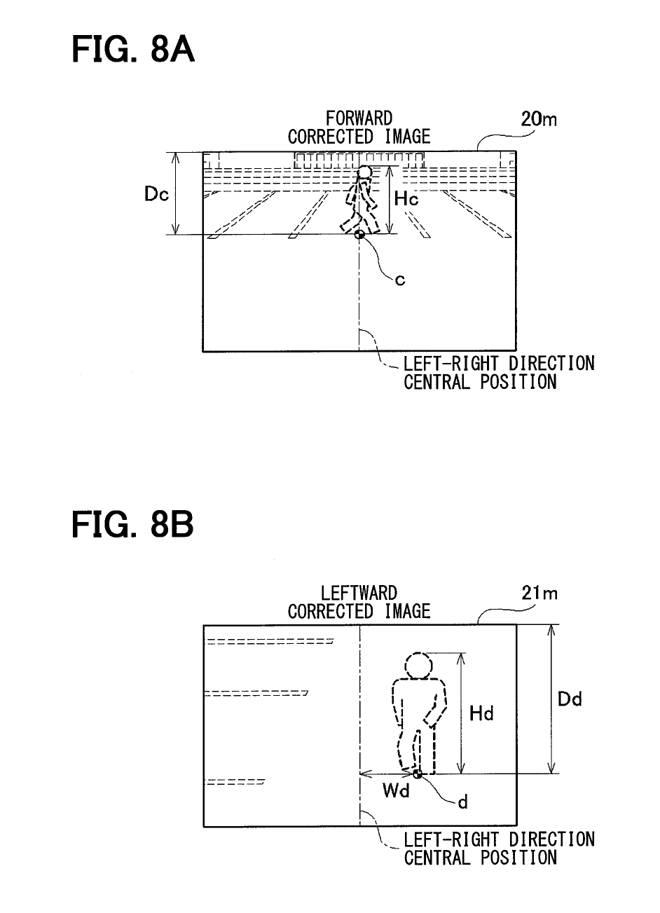

FIGS. 8A and 8B illustrate how the coordinate values of a detected pedestrian are stored. As illustrated, the coordinate values of feet of the detected pedestrian are stored as the coordinate values of the pedestrian. Thus, the up-down direction coordinate value of the pedestrian corresponds to the distance to the pedestrian. Further, it is conceivable that the height of the pedestrian is within the range of 1 to 2 m. Therefore, the size of an image of the pedestrian should fit into a range that is predetermined based on the distance to the pedestrian. Consequently, if the size of the detected pedestrian is not within the predetermined range, it can be determined that an erroneous detection is made.

In the example of FIG. 8A, for instance, point c indicates the feet of a pedestrian and an up-down direction coordinate value of point c indicates the feet of a pedestrian is Dc, and the size of the image of a pedestrian at this point is limited within a certain range. Therefore, a check is performed to determine whether the size Hc of a detected pedestrian is within the range. If the size Hc is within the range, it is determined that the pedestrian is correctly recognized. Thus, the result of detection is stored in the memory. If, by contrast, the size Hc is not within the range, it is determined that an erroneous detection is made. Thus, the result of detection is discarded without being stored. The same holds true for the example of FIG. 8B. More specifically, a check is performed to determine whether the size Hd of a detected pedestrian is within a range corresponding to the coordinate value Dd of point d of the feet of the pedestrian. If the size Hd is within the range, it is determined that the pedestrian is correctly recognized. Thus, the result of detection is stored in the memory. If, by contrast, the size Hd is not within the range, it is determined that an erroneous detection is made. Thus, the result of detection is discarded without being stored.

After a pedestrian in a corrected image is detected (S203) as described above, a vehicle shown in the corrected image is detected (S203). Vehicles in the corrected image are also detected by searching for a vehicle by using a template that describes features of an image showing the vehicle. When, for example, an automobile is to be detected, an automobile template is stored. When a bicycle is to be detected, a bicycle template is stored. When a motorcycle is to be detected, a motorcycle template is stored. Templates of various sizes are also stored. Automobiles, bicycles, motorcycles, and other vehicles shown in the image can be detected by searching the image by using the stored templates.

Further, when a vehicle is detected, the memory of the image display device 100 also stores information indicating whether the vehicle is detected from the forward corrected image 20m, the leftward corrected image 21m, the rightward corrected image 22m, or the rearward corrected image 23m, and stores the relevant coordinate values in the corrected image, and the type (e.g., automobile, bicycle, or motorcycle) and size of the vehicle.

Moreover, the coordinate values of a portion of the ground with which the vehicle is in contact are stored. In this instance, a check may be performed to determine whether the up-down direction coordinate value of the vehicle matches the size of the vehicle. If the up-down direction coordinate value of the vehicle does not match the size of the vehicle, it may be determined that an erroneous detection is made, and then the result of detection may be discarded.

Subsequently, an obstacle shown in the corrected image is detected (S205). Obstacles are also detected by using obstacle templates, as is the case with the aforementioned pedestrians and vehicles. However, obstacles vary in shape. Therefore, not all of the obstacles can be detected by using one type of template. Thus, power poles, triangular cones, guard rails, and certain other types of obstacles (predetermined obstacles) are predefined, and their templates are stored. Obstacles are then detected by searching the corrected image through the use of the templates.

When an obstacle is eventually detected, the memory of the image display device 100 stores information indicating whether the obstacle is detected from the forward corrected image 20m, the leftward corrected image 21m, the rightward corrected image 22m, or the rearward corrected image 23m, the relevant coordinate values in the corrected image, and the type and size of the obstacle.

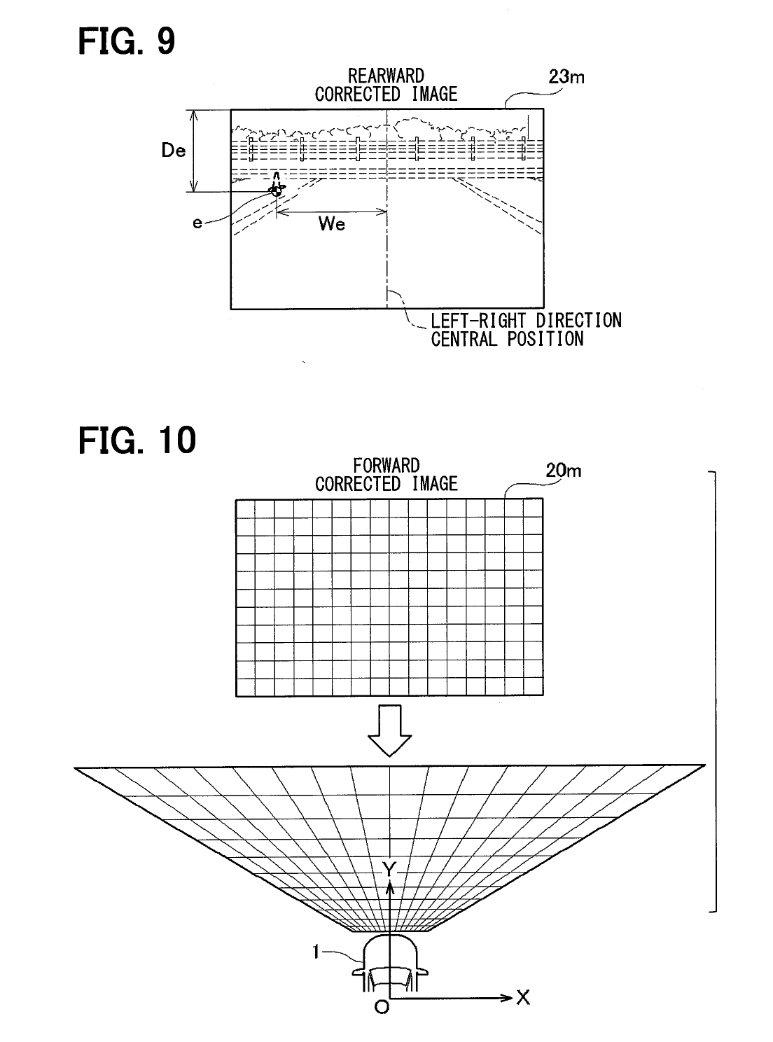

FIG. 9 illustrates how the coordinate values of a detected obstacle (triangular cone) are stored. As illustrated, the coordinate values (We, De) of point e, which indicates a position where the obstacle is in contact with the ground surface, also are stored as the coordinate values of the obstacle. Further, a check may also be performed to determine whether the up-down direction coordinate value De matches the size of the obstacle. If the up-down direction coordinate value of the obstacle does not match the size of the obstacle, it may be determined that an erroneous detection is made, and then the result of detection may be discarded.

After, for example, white lines, pedestrians, vehicles, and obstacles are detected as described above (steps S201 to S205), other mobile objects (e.g., rolling balls, animals, and other moving objects) are detected (S206). If a mobile object exists, for example, if a rolling ball or a rapidly approaching animal exists, contingency is likely to arise. Therefore, when a mobile object exists around the vehicle 1, it is preferable that the driver recognize the presence of such a mobile object. Consequently, mobile objects other than pedestrians and vehicles are also detected.

For mobile object detection, a currently acquired image is compared with the last acquired image to detect a moving object in the images. In this instance, information about the movement of the vehicle 1 (information indicative of the speed of the vehicle, the steering angle of a steering wheel, and the direction of vehicle movement (forward or rearward movement)) may be acquired from a vehicle control device (not shown) to exclude any overall image movement due to a change in an imaging range.

Coordinate values of various detected target objects are then converted to coordinate values in the coordinate system that has the origin at the vehicle 1 (i.e., the relative positions with respect to the vehicle 1), and the coordinate values stored in the memory are updated by the coordinate values derived from conversion (S207).

The above process is described below. For example, the forward corrected image 20 m shows a forward view from the vehicle 1. Thus, all coordinate values in the forward corrected image 20 m can be associated with various positions forward of the vehicle 1. Therefore, when these associations are predetermined, the coordinate values of a target object detected from the forward corrected image 20m as indicated in the upper half of FIG. 10 can be converted to coordinate values in the coordinate system that has the origin at the vehicle 1 as indicated in the lower half of FIG. 10.

Similarly, coordinate values in the leftward corrected image 21m, the rightward corrected image 22m, and the rearward corrected image 23m can be associated with leftward, rightward, and rearward coordinate values for the vehicle 1. Consequently, as far as these associations are predetermined, the coordinate values of target objects detected from the corrected images are converted to coordinate values in the coordinate system that has the origin at the vehicle 1.

When the coordinate values of all target objects are converted as described above to the coordinate values in the coordinate system having the origin at the vehicle 1, and stored in the memory, the image display device 100 terminates the target object detection process illustrated in FIG. 5 and returns to the bird's eye view image display process illustrated in FIG. 3.

Upon completion of the target object detection process, the image display device 100 generates a bird's eye view image (S101). The bird's eye view image is an image that shows the surroundings of the vehicle 1 in an overhead view style (in a bird's eye view style). In the above-described target object detection process, target objects existing around the vehicle 1 and their positions are determined by coordinate values in the coordinate system having the origin at the vehicle 1. Therefore, the bird's eye view image can easily be generated by displaying a target object image (an image of a figure indicative of a target object) at a position where the target object exists. The target object image will be described in detail later.

Subsequently, a marker image is displayed over target objects in the bird's eye view image, particularly, pedestrians, obstacles, and mobile objects (S102). The marker image is an image that is displayed to make a target object conspicuous. For example, a circular or rectangular figure enclosing a target object may be used as the marker image.

Further, the bird's eye view image is combined with the vehicle image (image indicative of the vehicle 1), which is overwritten at a position where the vehicle exists (S103).

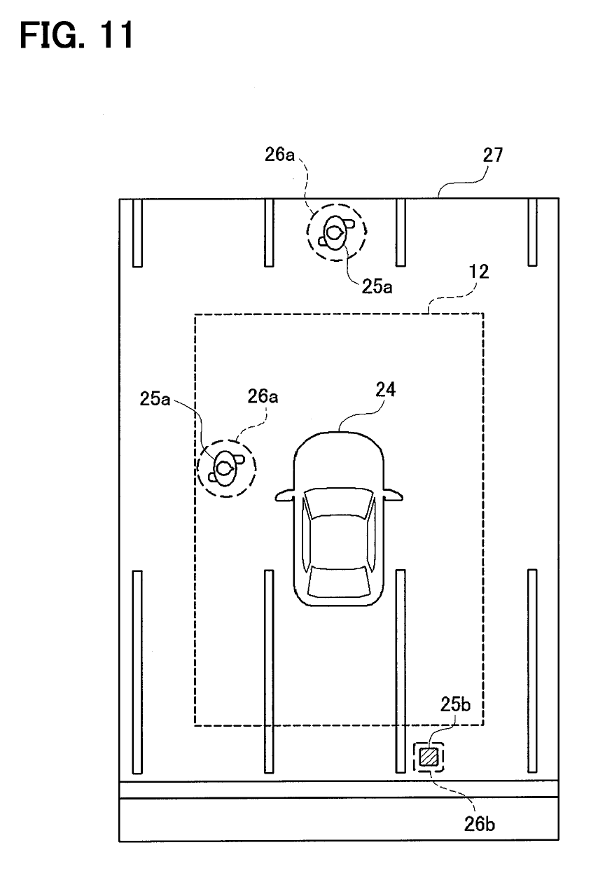

FIG. 11 illustrates a bird's eye view image 27 that is generated in the above-described manner. As mentioned earlier with reference to FIG. 4, a pedestrian is shown in the forward image 20 of the vehicle 1 and in the leftward image 21, and an obstacle is shown in the rearward image 23. Thus, the bird's eye view image 27 in FIG. 11 shows a target object image 25a indicative of a pedestrian forward and leftward of the vehicle 1. Similarly, the bird's eye view image in FIG. 11 shows a target object image 25b indicative of an obstacle rearward of the vehicle 1.

Furthermore, a pedestrian marker image 26a and an obstacle marker image 26b are respectively displayed over the pedestrian target object image 25a and the obstacle target object mage 25b. Moreover, the bird's eye view image 27 is combined with the vehicle image 24 indicative of the vehicle 1, which is overwritten at a position where the vehicle exists. Additionally, white line images are displayed around the vehicle image 24.

When various target objects are detected from images captured by the on-vehicle cameras 10F, 10R, 11L, 11R on the vehicle 1 and the bird's eye view image is generated based on the result of detection as described above, information that need not be presented to the driver can be prevented from being displayed. Thus, as illustrated in FIG. 11, the surroundings of the vehicle 1 can be displayed to the driver in a very easy-to-understand manner. Further, as the marker images are displayed over pedestrians, obstacles, and other target objects that require the particular attention of the driver, the driver can be alerted to such target objects. Additionally, as the vehicle image 24 is displayed at a position where the vehicle 1 exists, it is easy to grasp the positional relationship between the vehicle 1 and the target objects such as pedestrians and obstacles.

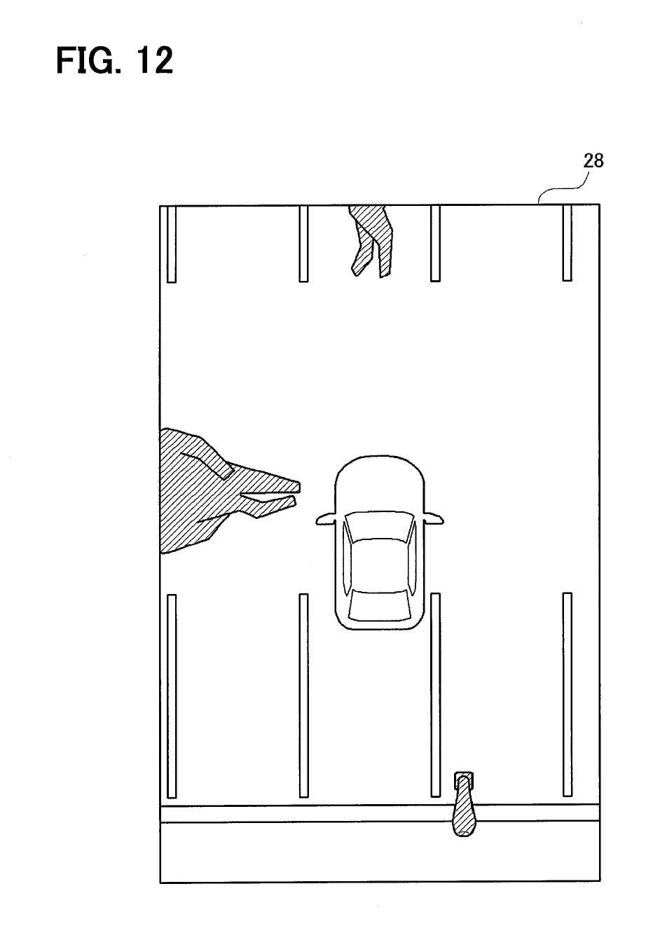

When a bird's eye view image is generated by subjecting captured images to viewpoint conversion, the image of a target object may become significantly distorted. When, for example, the forward image 20, leftward image 21, rightward image 22, and rearward image 23 illustrated in FIG. 4 are subjected to viewpoint conversion in order to generate the bird's eye view image 28, the images of pedestrians and obstacles may become significantly distorted as illustrated in FIG. 12 so that the driver is unable in some cases to immediately recognize the pedestrians and obstacles.

Meanwhile, the present embodiment, which is described above, extracts information about the presence of target objects shown in the captured images and the positions of the target objects, and generates a bird's eye view image based on the extracted information. As a result, a very easy-to-understand bird's eye view image 27 can be generated as illustrated in FIG. 11.

However, the bird's eye view image 27 obtained in the above manner shows a large area around the vehicle 1. It signifies that when a bird's eye view image is generated based on the information about the positions of target objects shown in the captured images, the images of the target objects are displayed without being distorted to permit the generation of a bird's eye view image 27 showing a large area. When the bird's eye view image 27 showing a large area is to be displayed on the display screen 12, the bird's eye view image 27 needs to be reduced in size for display purposes. As a result, the driver cannot easily recognize the surroundings of the vehicle 1.

In view of the above circumstances, the bird's eye view image display process according to the present embodiment acquires the shift position of the vehicle 1 (S104 in FIG. 3). As mentioned earlier with reference to FIG. 2, the shift position indicates whether the transmission (not shown) mounted in the vehicle 1 is placed in the Drive position (D), the Reverse position (R), the Neutral position (N), or the Park position (P). The shift position can be detected from an output from the shift position sensor 14.

After the shift position is acquired, the predetermined scope is cut out from the bird's eye view image 27 in accordance with the shift position, and image data on the cut-out image is outputted to the display screen 12 (S105).

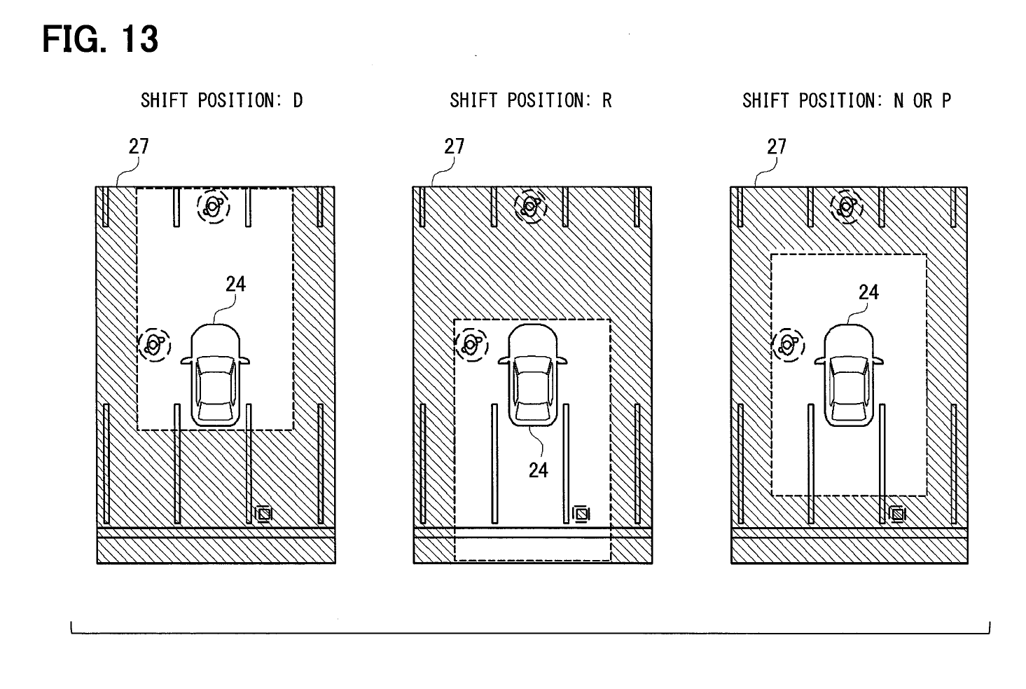

FIG. 13 illustrates how the predetermined scope is cut out from the bird's eye view image 27 in accordance with the shift position. When, for example, the shift position is Drive (D), the predetermined scope is cut out from the bird's eye view image 27 so that a forward portion of the cut-out image of the vehicle 1 has a larger area than a rearward portion as indicated in FIG. 13. Referring to FIG. 13, an unshaded portion of the bird's eye view image 27 is cut out. When the shift position is Reverse (R), the predetermined scope is cut out from the bird's eye view image 27 so that a rearward portion of the cut-out image of the vehicle 1 has a larger area than a forward portion as indicated in FIG. 13. When the shift position is Neutral (N) or Park (P), the predetermined scope is cut out from the bird's eye view image 27 so that forward and rearward portions of the image of the vehicle 1 have the same area as indicated in FIG. 13.

Image data on the image cut out from the bird's eye view image 27 as described above is then outputted (S105). As a result, the display screen 12 displays the image that is cut out in accordance with the shift position.

Subsequently, a check is performed to determine whether or not to terminate the display of the bird's eye view image (S106 in FIG. 3). If the result of determination indicates that the display of the bird's eye view image is not to be terminated (S106: NO), the image display device 100 returns to the beginning of the bird's eye view image display process, acquires captured images again from the on-vehicle cameras 10F, 10R, 11L, 11R (S100), and repeats the above-described series of subsequent processing steps.

If, by contrast, the result of determination indicates that the display of the bird's eye view image is to be terminated (S106: YES), the image display device 100 terminates the bird's eye view image display process according to the present embodiment, which is illustrated in FIG. 3.

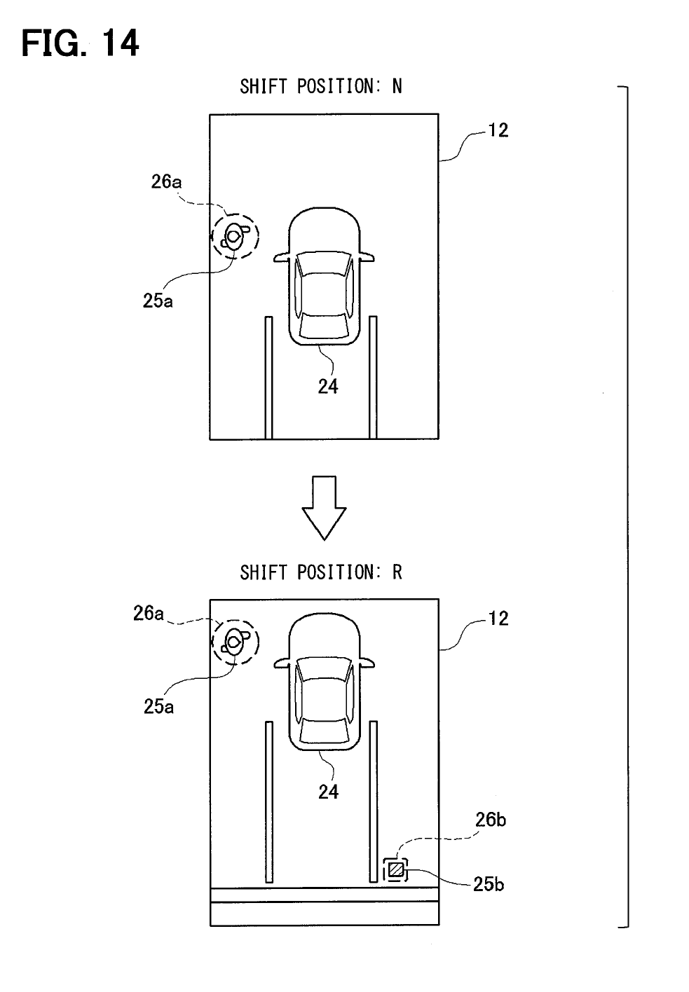

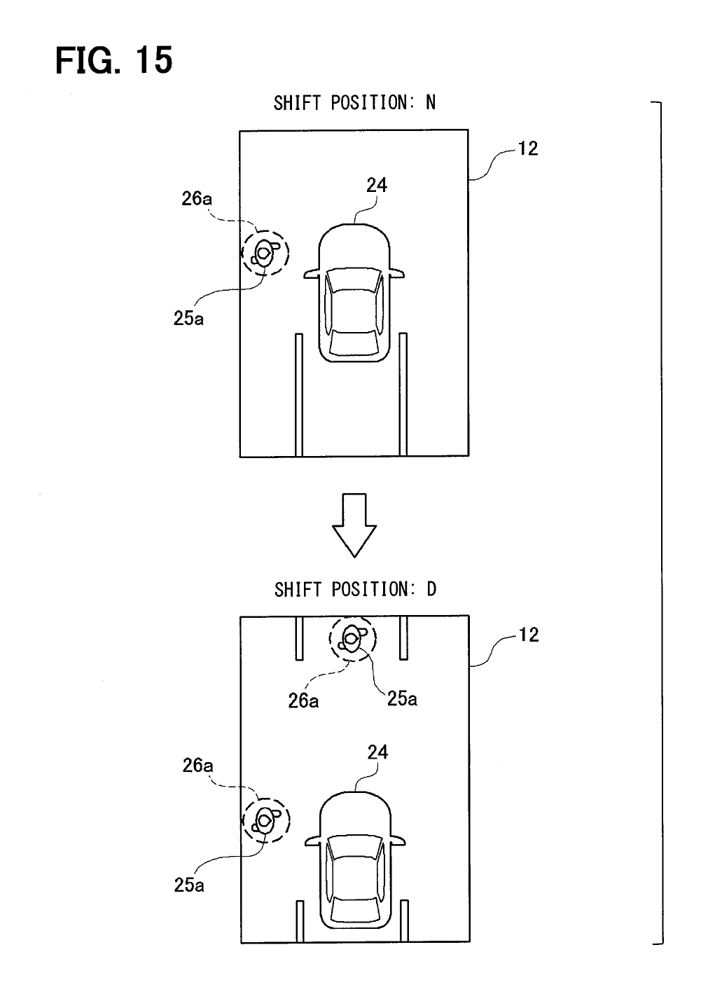

FIGS. 14 and 15 illustrate images that appear on the display screen 12 when the above-described bird's eye view image display process is performed. When, for example, the shift position is Neutral (N) as indicated in the upper half of FIG. 14, the vehicle image 24 is displayed substantially at the center of the display screen 12. In this instance, the driver can entirely grasp the forward and rearward surroundings.

Obviously, the display screen 12 cannot display a very large area. However, when the shift position is Neutral (N), the vehicle 1 is stopped. Therefore, the driver is not highly likely to want to view a distant area. The driver would be satisfied as far as he or she is able to view a nearby area.

When the shift position is subsequently changed to Reverse (R) in order to reverse the vehicle 1, the rearward portion of the displayed image of the vehicle 1 has a larger area than the forward portion as indicated in the lower half of FIG. 14. When the vehicle 1 is to be reversed, the driver is highly likely to want to view a distant rearward area as well. Therefore, necessary information can be presented to the driver when emphasis is placed on the rearward portion of the displayed image of the vehicle 1 as described above. In the example of FIG. 14, an obstacle in the rear is visible on the display screen 12 when the shift position is changed to Reverse (R). This obstacle was not displayed when the shift position was Neutral (N).

Further, as mentioned earlier, the present embodiment is capable of displaying a bird's eye view image 27 that shows a distant area as well without being distorted. Therefore, even when an area distant from the vehicle 1 is to be displayed, the bird's eye view image 27 can be displayed to the driver in an easy-to-recognize manner.

The display screen 12 presents target objects by displaying their target object images 25a, 25b. As regards target objects that require particular attention, however, the display screen 12 additionally displays marker images over the target object images. This enables the driver to easily recognize the target objects.

Moreover, when the shift position is changed from Neutral (N) to Drive (D), the display screen 12 switches from the contents shown in the upper half of FIG. 15 to the contents shown in the lower half. When the vehicle 1 moves forward, the driver is highly likely to want to view a distant forward area as well. Therefore, necessary information can be presented to the driver when the contents of the display screen 12 are as shown in the lower half of FIG. 15.

In the example of FIG. 15, a pedestrian 25a existing in the front is visible on the display screen 12 when the shift position is changed to Drive (D). This pedestrian 25a was not displayed when the shift position was Neutral (N).

While the embodiment of the present disclosure has been illustrated above, it should be understood that the present disclosure is not limited to the above-illustrated embodiment and may include various other embodiments which remain within the scope and spirit of the present disclosure.

1. An image display device that is applied to a vehicle equipped with an on-vehicle camera and a display screen for displaying an image captured by the on-vehicle camera, and that displays on the display screen an image showing the surrounding of the vehicle in a bird's eye view style for showing an overhead view of the vehicle, the image display device comprising:
a captured image acquisition section that acquires the captured image from the on-vehicle camera;
a bird's eye view image generation section that generates, based on the captured image, a bird's eye view image showing the surrounding of the vehicle in the bird's eye view style;
a vehicle image combination section that combines a vehicle image showing the vehicle with the bird's eye view image by placing the vehicle image at a position of the vehicle in the bird's eye view image;
a shift position detection section that detects a shift position of the vehicle; and
an image output section that cuts out a predetermined scope corresponding to the shift position of the vehicle from the bird's eye view image with which the vehicle image is combined and outputs the cut-out image to the display screen,
wherein:
the bird's eye view image generation section includes
a target object extraction section that extracts, as a target object, an obstacle or a mobile object shown in the captured image, and
a relative position detection section that, based on a position of the extracted target object in the captured image, detects the relative position of the target object with respect to the vehicle; and
upon detection of the target object by the target object extraction section, the bird's eye view image generation section combines the bird's eye view image with a predetermined marker image and a target object image indicative of the target object in such a manner as to place the target object image and the predetermined marker image at a position indicated by the relative position of the target object, and thereby generates the bird's eye view image including the target object image and the predetermined marker image in place of the target object.

2. The image display device according to claim 1, wherein
when the shift position of the vehicle is Drive, the image output section cuts out the predetermined scope of image and outputs the cut-out image to the display screen, the predetermined scope being defined to make a forward portion of the cut-out image of the vehicle larger in area than a rearward portion.

3. The image display device according to claim 1, wherein
when the shift position of the vehicle is Reverse, the image output section cuts out the predetermined scope of image defined to make a rearward portion of the cut-out image of the vehicle larger in area than a forward portion and outputs the cut-out image to the display screen.

4. (canceled)

5. (canceled)

6. An image display method that is applied to a vehicle having an on-vehicle camera and a display screen for displaying an image captured by the on-vehicle cameras, and that displays on the display screen an image showing the surrounding of the vehicle in a bird's eye view style for showing an overhead view of the vehicle, the image display method comprising:
acquiring the captured image from the on-vehicle camera;
generating a bird's eye view image based on the captured image, the bird's eye view image being adapted to show the surrounding of the vehicle in the bird's eye view style;
combining a vehicle image showing the vehicle with the bird's eye view image by placing the vehicle image at the position of the vehicle in the bird's eye view image;
detecting a shift position of the vehicle; and
cutting out a predetermined scope corresponding to the shift position of the vehicle from the bird's eye view image with which the vehicle image is combined, and outputting the cut-out image to the display screen,
wherein:
generating the bird's eye view image includes
extracting, as a target object, an obstacle or a mobile object shown in the captured image, and
detects the relative position of the target object with respect to the vehicle based on a position of the extracted target object in the captured image; and
generating the bird's eye view image further includes, upon detection of the target object, combining the bird's eye view image with a predetermined marker image and a target object image indicative of the target object in such a manner as to place the target object image and the predetermined marker image at a position indicated by the relative position of the target object, and thereby generating the bird's eye view image including the target object image and the predetermined marker image in place of the target object.
